(19) United States
(12) Patent Application Publication
(10) Pub. No.: US 2008/0211631 A1
(43) Pub. Date: Sep. 4, 2008

(54) Wireless tag position estimation device, wireless tag communication device, wireless tag position estimation system, wireless tag position estimation method, and wireless tag position estimation program

(75) Inventor: Masashi Sakamoto, Nara (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/984,273

(22) Filed: Nov. 15, 2007

(30) Foreign Application Priority Data
Dec. 22, 2006 (JP) 2006-346528

(51) Int. Cl. H04Q 5/22

(52) U.S. Cl. 340/10.1

(57) ABSTRACT

There is provided a wireless tag position estimation system which includes a wireless tag communication device and a wireless tag position estimation device and estimates a position of an article on which a wireless tag is fitted regardless of an arrangement, an appearance, and a package of the article. The wireless tag communication device includes a unit which irradiates a radiowave from a predetermined position and direction to the wireless tag, and a unit which receives a response signal from the wireless tag with respect to radiowave irradiation. The wireless tag position estimation device includes a unit which estimates information about a specific position and direction which irradiates a radiowave when a response from the wireless tag can be received on the basis of the information received by the wireless tag communication device, and a unit which estimates the position of the wireless tag on the basis of estimated information.

### CROSS REFERENCE TO RELATED APPLICATIONS

The disclosure of Japanese Patent Application No. JP2006-346528, filed Dec. 22, 2006, entitled “wireless tag position estimation device, wireless tag communication device, wireless tag position estimation system, wireless tag position estimation method, and wireless tag position estimation program”. The contents of that application are incorporated herein by reference in their entirety.

### BACKGROUND OF THE INVENTION

1. Field of the Invention

The present invention relates to a wireless tag position estimation device, a wireless tag communication device, a wireless tag position estimation system, a wireless tag position estimation method, and a wireless tag position estimation program. The present invention can be applied to estimation of a position of a concealed wireless tag.

2. Description of the Related Art

An RFID (Radio Frequency IDentification) technique has been studied as a merchandise identification/management technique in place of a bar-code technique in a business field of distribution. However, the RFID technique is not limited to this field, and attracts attention as a social fundamental technology to promote an IT society or an automated society. As the reason why the RFID technique is replaced with a bar-code technique and attracts attention as a social fundamental technology is non-contact authentication and simultaneous multiple authentication. For example, when articles are put into a shopping cart and brought to a checkout counter, a clerk at the checkout counter repeats an operation which picks up the articles one by one and checks positions of bar codes on the articles to apply a bar code reader to the articles or changes the direction of an article such that the bar code of the article is caused to face the bar code reader to approximate the article to the bar code reader.

When an RFID tag is stuck on each article, it is considered that all the articles in a cart can be simultaneously subjected to an RFID tag reader to perform authentication and settle an account. The non-contact authentication and the simultaneous multiple authentication are expected to spectacularly improve the efficiency of merchandise management.

Since the RFID tag does not have a direct relation with an amount of ID information held by the tag and a size of the tag itself, a tag having an amount of information which is considerably larger than that of a bar code can be obtained. In this manner, not only a category and a type of an article expressed by a current bar code, but also ID information of each article corresponding to a production number can be held in the tag.

In a normal bar code tag, only pieces of information such as a country of manufacture, a manufacturer, a category, a type, and the like of an article are coded and held. For this reason, in order to more exactly specify the article, pieces of ID information of various styles such as a date of manufacture, an expiration date, a recommended use-by date, a production lot sign, and a production serial number must be used. Furthermore, methods for displaying and coding the pieces of ID information vary depending on manufacturers. In each store, a production lot sign of an arrival article is not copied. In this case, little more than information such as the number of sold productions can be estimated from the number of products which remain unsold in a store and can be collected.

In contrast to this, when an RFID tag is fit on each article, as at a checkout counter in the supermarket or the like, it is considered that, by non-contact authentication and simultaneous multiple authentication, all articles in a package such as a cardboard box when the articles in a cardboard box are carried in a store can be subjected to an RFID tag reader to perform authentication and recording. In response to the technology trends, development of a technique which tries to utilize the characteristic features of the non-contact authentication, the simultaneous multiple authentication, and the like by RFID tag is encouraged.

An device described in Japanese Patent Application Laid-Open No. 2006-40035 is an device which reads ID data of RFID tags simultaneously with an image-pickup operation and compares amounts of characteristic (appearance model) of objects on which the RFID tags are fitted with an amount of characteristic obtained by image processing of the picked image to discriminate the objects on which the RFID tags are fitted in the image. According to the device, for example, when an amount of characteristic of an object such as a color is apparent, a means which can determine information of a specific RFID tag when ID data read from the plurality of RFID tags can be relatively easily obtained.

In an device described in Japanese Patent Application Laid-Open No. 2006-40059, by using a receiving antenna having a directivity, a parameter control unit controls a read parameter and a photographic parameter such that a read range applied when an RFID reading unit reads information of an RFID tag fitted on an object or the like coincides with a photographic range applied when an image photographing unit photographs the object. In this manner, it is assumed that objects on which RFID tags are fitted are relatively randomly arranged to solve a problem in which a photographed object and ID information from an RFID tag have one-to-one correspondence.

However, in the method disclosed in Japanese Patent Application Laid-Open No. 2006-40035, for example, when a book of an author, for example, “Natsume” having a capital letter in the “Na line” of the 50-character kana syllabary is put on a bookshelf on which books of authors having capital letters in the “A line, Ka line, and Sa line” of the 50-character kana syllabary are arranged in order of the author names according to the Japanese syllabary in a bookstore, a library, or the like, information of the wrong arrangement itself can be obtained from the RFID tag. However, when the scroops of books are arranged as on a bookshelf, characteristics in appearance such as colors and shapes are rarely obtained. For this reason, in order to return the book of the author, i.e., “Natsume” to a bookshelf where books of authors having capital letters in the “Na line” of the 50-character kana syllabary, the scroops of the books arranged on the bookshelf are visually checked to find out the book. If the book has a characteristic in appearance enough to be specified by the method disclosed in Japanese Patent Application Laid-Open No. 2006-40035, an operator can find out the book at a glance. For this reason, it is unnecessary to use any device which realize the method disclosed in Japanese Patent Application Laid-Open No. 2006-40035.

For example, an RFID tag is fitted on a tray of food in a supermarket. When a recommended use-by date of a small portion of food approaches, information of the recommended use-by date itself can be obtained from the RFID tag. However, in general, articles of the same category are gathered at the same place, differences in appearance may be only small-size numbers to express recommended use-by dates. In order to select an article the recommended use-by date of which approaches, the operator must visually check recommended use-by dates of the articles one by one. Furthermore, for example, when the articles are packaged in a cardboard box or the like, the characteristics in appearance cannot be obtained at all. For this reason, the method disclosed in Japanese Patent Application Laid-Open No. 2006-40035 is not effective for management of respective articles of the same category and the same type. It is effective only for the case of objects to be managed have conspicuous characteristics in appearance.

In the method disclosed in Japanese Patent Application Laid-Open No. 2006-40059, in the above case, articles such as books and trays of food are photographed one by one. As a result, the function cannot be obtained unless an operator picks up articles one by one and moves the articles to a place separated from other articles.

For this reason, a wireless tag position estimation device, a wireless tag communication device, a wireless tag position estimation system, a wireless tag position estimation method, and a wireless tag position estimation program which can estimate the positions of articles on which wireless tags are fitted regardless of statuses of arrangements, appearances, and packages of the articles are desired.

### SUMMARY OF THE INVENTION

A first aspect of the present invention, there is provided a wireless tag communication device which transmits and receives information to/from a wireless tag with wireless communication and which provides information related to the wireless tag to a wireless tag position estimation device which estimates a position of the wireless tag, including: (1) radiowave irradiation means which irradiates a radiowave to transmit information to the wireless tag; (2) radiowave receiving means which receives a response radiowave from the wireless tag in response to radiowave irradiation by the radiowave irradiation means; and (3) wireless tag response information transmission means which transmits information related to a communication direction obtained by transmission/reception with the wireless tag to the wireless tag position estimation device, wherein (4) at least one of that the radiowave irradiation means irradiates a radiowave having a directivity in a predetermined direction at a predetermined position and that the radiowave receiving means receives only a response radiowave transmitted from the predetermined direction at the predetermined position is applied.

According to a second aspect of the present invention, there is provided a wireless tag position estimation device which estimates a position of a wireless tag on the basis of information from a wireless tag communication device which transmits and receives information to/from the wireless tag, including: (1) wireless tag response direction estimation means which estimates information about a specific position at which a response radiowave from the wireless tag can be received in communication and a specific direction in which the response radiowave can be received in communication on the basis of the information from the wireless tag communication device; and (2) wireless tag position estimation means which estimates the position of the wireless tag on the basis of information of a plurality of response directions estimated by the wireless tag response direction estimation means.

According to a third aspect of the present invention, there is provided a wireless tag position estimation device including a wireless tag communication device according to the first aspect of the present invention and a wireless tag position estimation device according to the second aspect of the present invention.

According to a fourth aspect of the present invention, there is provided a wireless tag position estimation method including: (0) a wireless tag communication device which transmits and receives information to/from the wireless tag, and a wireless tag position estimation device which estimates a position of the wireless tag on the basis of information from the wireless tag communication device, wherein (1) the wireless tag communication device has a configuration in which a direction of communication with the wireless tag when viewed from a certain position, and, with this configuration, information related to the acquired communication direction to the wireless tag position estimation device, and (2) the wireless tag position estimation device obtains information of a plurality of response directions representing a specific position at which a response radiowave from the wireless tag can be received in communication and a specific direction in which the response radiowave can be received in communication on the basis of the information from the wireless tag communication device and then estimates the position of the wireless tag.

According to a fifth aspect of the present invention, there is provided a wireless tag position estimation program mounted on a computer which constructs a wireless tag position estimation device which estimates a position of the wireless tag on the basis of information from a wireless tag communication device which transmits and receives information to/from the wireless tag, wherein (0) the computer is caused to function as (1) wireless tag response direction estimation means which estimates information about a specific position at which a response radiowave from the wireless tag can be received in communication and a specific direction in which the response radiowave can be received in communication on the basis of the information from the wireless tag communication device; and (2) wireless tag position estimation means which estimates the position of the wireless tag on the basis of information of a plurality of response directions estimated by the wireless tag response direction estimation means.

According to the present invention, a position of an article on which a wireless tag is fitted can be estimated regardless of statuses of an arrangement, an appearance, and a package of the article.

### BRIEF DESCRIPTION OF THE DRAWINGS

FIG. 1 is a block diagram showing a functional configuration of a first embodiment;

FIG. 2 is a sequence diagram showing an operation which estimates a position of a wireless tag 105b to cause the position to visualize in the first embodiment;

FIG. 3 is an explanatory diagram showing a track of a radiowave irradiated by a radiowave irradiation unit 101b;

FIG. 4 is an explanatory diagram showing a position where a response is transmitted from the wireless tag 105b in response to radiowave irradiation in the first embodiment;

FIG. 5 is an explanatory diagram showing an example of an image obtained by causing an estimated position of the wireless tag 105b to visualize in the first embodiment;

FIG. 6 is a block diagram showing a functional configuration of a second embodiment;

FIG. 7 is an explanatory diagram showing an estimation direction of a wireless tag 604b when a wireless tag communication device 601 irradiates radiowaves to a cardboard box 604 in three directions in the second embodiment; and

FIG. 8 is a sequence diagram showing an operation which estimates a position of the wireless tag 604b to cause the position to visualize in the second embodiment.

### DETAILED DESCRIPTION OF THE PREFERRED EMBODIMENTS

### (A) First Embodiment

A first embodiment of a wireless tag position estimation device, a wireless tag communication device, a wireless tag position estimation system, a wireless tag position estimation method, and a wireless tag position estimation program will be described in detail with reference to the accompanying drawings.

### (A-1) Configuration of First Embodiment

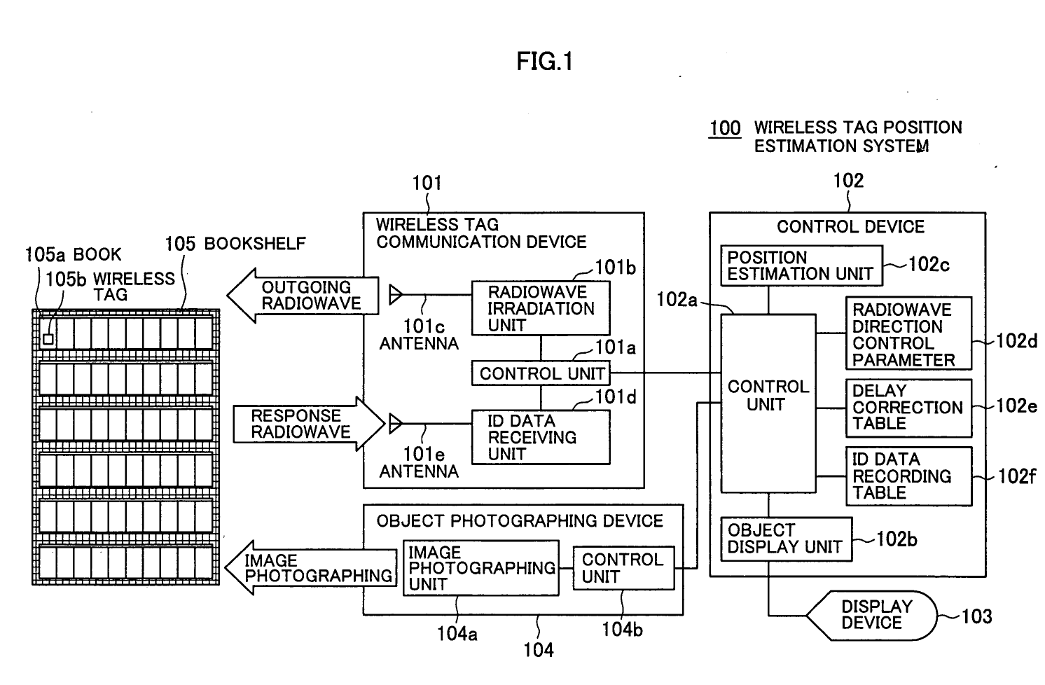

FIG. 1 is a block diagram showing a functional configuration of a wireless tag position estimation system according to the first embodiment.

A wireless tag position estimation system 100 has a wireless tag communication device 101, a control device 102, a display device 103, and an object photographing device 104 which are roughly divided. The wireless tag position estimation system 100 mainly acquires position information of a wireless tag 105b to display a result of the information.

The wireless tag 105b is a tag in which information can be wirelessly read and written. For example, as the tag, an existing RFID (Radio Frequency Identification) tag can be applied. In the first embodiment, it is assumed that the wireless tag 105b is fitted on a book 105a accommodated in a bookshelf 105 having a total of 6 stages. Although wireless tags are fitted on all the books in the 6-stage bookshelf 105, respectively, the wireless tags are omitted in FIG. 1 for ease of explanation.

Under the control of the control device 102, the wireless tag communication device 101 functions to irradiate a radiowave toward a target wireless tag 105b the position of which is to be estimated and to transmit information to the control device 102 with respect to a status of a response from the wireless tag 105b.

The wireless tag communication device 101 has a control unit 101a, a radiowave irradiation unit 101b, and an ID data receiving unit 101d.

The control unit 101a functions to control of operations of the radiowave irradiation unit 101b and the ID data receiving unit 101d on the basis of information received from the control device 102 and to transmit the information or the like received from the wireless tag 105b to the control device 102.

The radiowave irradiation unit 101b functions to irradiate a radiowave toward the wireless tag 105b and has an antenna 101c. The radiowave irradiation unit 101b controls the antenna 101c and outputs a radiowave while gradually changing a direction of the radiowave to be transmitted. At this time, the control device 102 changes a direction in which the radiowave is transmitted on the basis of a control signal from the control device 102. As a means which changes a direction of a radiowave to be transmitted, a scheme which physically moves the direction of an antenna having a high directivity (mechanical scheme) and a scheme which controls the direction of a radiowave by electric control like a phased array antenna (electronic scheme) are given. Unlike a laser beam or the like, a radiowave does not have a thin beam-like shape even though an antenna having a high directivity, and spreads to some extent. Therefore, the direction of the radiowave mentioned here a direction of a central part of the radiowave having the spread.

As a signal to the wireless tag 105b included in the radiowave irradiated from the radiowave irradiation unit 101b, for example, a command which causes the wireless tag 105b to respond to ID data of the wireless tag 105b is continuously transmitted. When the wireless tag 105b is free from a built-in battery and operates by an electromagnetic wave supplied from an external device (passive tag), a radiowave to supply an electric power is simultaneously transmitted. The radiowave irradiation unit 101b may have a plurality of antennas 101c to irradiate radiowaves.

The ID data receiving unit 101d functions to receive a radiowave signal of a response from the wireless tag 105b and to input information based on the received signal to the control unit 101a, and has an antenna 101e. The antenna 101e needs not have a directivity especially unlike the antenna 101c. The antenna 101e can receives a radiowave of a response even if the wireless tag 105b is arranged at any position of the bookshelf 105. The ID data receiving unit 101d may be constructed to have a plurality of antennas so as to receive radiowaves.

The control device 102 functions to control operations of the devicees, to collect information to estimate a position of the wireless tag 105b, and to estimate the position on the basis of the information. The control device 102 has a control unit 102a, an object display unit 102b, a position estimation unit 102c, a radiowave direction control parameter 102d, a delay correction table 102e, and an ID data recording table 102f.

The control device 102 is constructed such that a wireless tag position estimation program (including fixed data) according to the embodiment is installed in an information processing device such as a personal computer (the number of which is not limited to one, and which may be constituted by arranged a plurality of devicees to make it possible to perform distributed processing). The control device 102 can be functionally expressed as shown in FIG. 1. The control unit 102a, the object display unit 102b, and the position estimation unit 102c correspond to a CPU (Central Processing Unit) and the like of the control device 102 as hardware and correspond to various programs as software. The radiowave direction control parameter 102d, the delay correction table 102e, and the ID data recording table 102f correspond to storage resources constituted by a volatile storage means (RAM or the like) and a nonvolatile storage means (ROM, hard disk, or the like) as hardware, and correspond to various files as software.

The radiowave direction control parameter 102d is information showing a direction of irradiation of a radiowave obtained by the radiowave irradiation unit 101b of the wireless tag communication device 101 and a change of the direction. In the radiowave direction control parameter 102d, for example, information such as a direction in which the radiowave irradiation unit 101b begins to irradiate a radiowave, a change of the direction of irradiation thereafter, a rate of the change of the direction is stored. The radiowave direction control parameter 102d is also transmitted to the object photographing device 104 by the control unit 102a, and a control unit 104b determines a photographing range of an image on the basis of the information.

The delay correction table 102e is a table to store information about characteristics of wireless tags about time from when the wireless tag communication device 101 irradiates radiowaves to when wireless tags respond to the radiowaves. It is assumed that, in the delay correction table 102e, for example, types of wireless tags and information of average response time of the wireless tags of the types are stored.

The ID data recording table 102f is a table to store response information from the wireless tag 105b received by the ID data receiving unit 101d and time when a response is received as delay time. The response information includes ID data or the like of the wireless tag 105b. As receiving time, time when irradiation of a radiowave is started by the radiowave irradiation unit 101b is defined as 0, elapsed time from the start time is expressed as delay time. Even though a response is received from the same wireless tag 105b more than once, receptions having different delay times are recorded as different receptions, respectively.

The control unit 102a functions to control operations of means of the control device 102. The control unit 102a is connected to the object display unit 102b, the position estimation unit 102c, the radiowave direction control parameter 102d, the delay correction table 102e, and the ID data recording table 102f. The control unit 102a are connected to the control unit 101a of the wireless tag communication device 101 and the control unit 104b of the object photographing device 104 and functions to transmit and receive information between the devices. An existing USB (Universal Serial Bus), a LAN interface (wired/wireless), or the like can be applied to connection to another device, and, as a connection method therefor, any connection method may be used.

The control unit 102a functions to update the ID data recording table 102f on the basis of information from the wireless tag communication device 101. The control device 102 inputs the information of the radiowave direction control parameter 102d to the wireless tag communication device 101 and starts measurement of delay time such that time when a signal for starting irradiation a radiowave thereafter is input is defined as 0 second. Each time ID data or the like is input as response information of the wireless tag 105b from the wireless tag communication device 101, information of the ID data or the like and information of delay time when the ID data is input are added to the ID data recording table 102f.

The control unit 102a updates the information of the ID data recording table 102f to correct the data of the ID data recording table 102f on the basis of the information of the delay correction table 102e. In the data correction, for example, as described above, since information of response times or the like are stored in the delay correction table 102e in units of types of wireless tags, delay time related to the corresponding wireless tag 105b in the ID data recording table 102f is corrected such that a value corresponding to the characteristic of the wireless tag 105b is added or subtracted.

The control unit 102a inputs information of the radiowave direction control parameter 102d and the ID data recording table 102f to the position estimation unit 102c and receives an input of a result of estimated position information. The control unit 102a inputs information of an image input from the object photographing device 104 to the object display unit 102b together with the information of the estimated position input from the position estimation unit 102c.

The position estimation unit 102c functions to estimate a position of the wireless tag 105b on the basis of the information of the radiowave direction control parameter 102d and the ID data recording table 102f input from the control unit 102a and to input the information to the control unit 102a.

A method of estimating a position of the wireless tag 105b will be described below. By the radiowave direction control parameter 102d, the wireless tag communication device 101 can obtain information about a direction of irradiation and how many seconds after irradiation of a radiowave is started. By the ID data recording table 102f, information about how many seconds after irradiation of a radiowave is started a radiowave is irradiated on a specific position on the bookshelf 105 the wireless tag 105b responds can also be obtained. According to the above information, information about a position of an irradiated radiowave on the bookshelf 105 can be obtained when a response from the wireless tag 105b is obtained. For this reason, on the basis of the information, the position of the wireless tag 105b can be estimated. For example, it may be estimated that the target wireless tag 105b is present in a region having a large number of responses to irradiation of radiowaves. A center of gravity of a set of center points of irradiated radiowaves is calculated when a response to irradiation of a radiowave is obtained, and the center of gravity may be set as an estimated position.

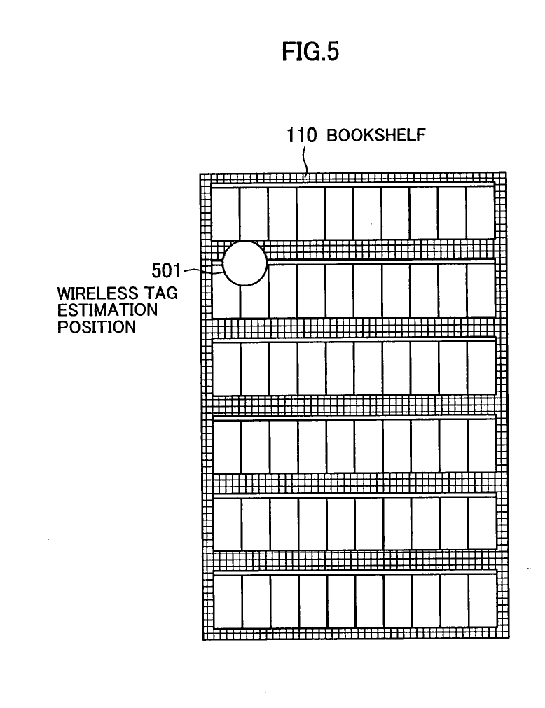

The object display unit 102b functions to generate an image to cause a user to visualize the estimated position of the wireless tag 105b on the bookshelf 105 on the basis of the information of the estimated position of the wireless tag 105b input from the control unit 102a and the information of the image input from the object photographing device 104 and to transmit the image information to the display device 103. The image generated here may be obtained by writing a circle or the like serving as a mark on a point where the wireless tag 105b is estimated to be positioned on the image of the bookshelf 105 as shown in FIG. 5. The object display unit 102b causes the display device 103 to display the result thereon when the display device 103 is a display, and the object display unit 102b causes the display device 103 to print the result. That is, the object display unit 102b employs any output method.

The object photographing device 104 functions to photograph an image about a range in which the radiowave irradiation unit 101b is irradiated and to transmit the photographed image to the control device 102. The object photographing device 104 has an image photographing unit 104a and a control unit 104b.

The image photographing unit 104a functions to photograph an image on the basis of information received from the control unit 102a and to input information of a photographed image to the control unit 104b. As the image photographing unit 104a, an image photographing device such as an existing CCD camera or the like can be applied.

The control unit 104b functions to control the image photographing unit 104a on the basis of the information of the radiowave direction control parameter 102d received from the control device 102 to photograph an image and to transmit information of the photographed image to the control device 102. As a photographing range of the image, a range including all ranges in which radiowaves are irradiated is determined on the basis of, for example, the information of the radiowave direction control parameter 102d. At this time, as a method of photographing an image, for example, the control unit 104b controls the object photographing device 104 to perform photographing while adjusting a direction and a magnification of the camera such that an image of the determined photographing range can be photographed. Alternatively, an image of the determined photographing range can be cut from the image photographed by the image photographing unit 104a.

### (A-2) Operation of First Embodiment

An operation of the wireless tag position estimation system 100 according to the first embodiment having the above functional configuration will be described below with reference to drawings.

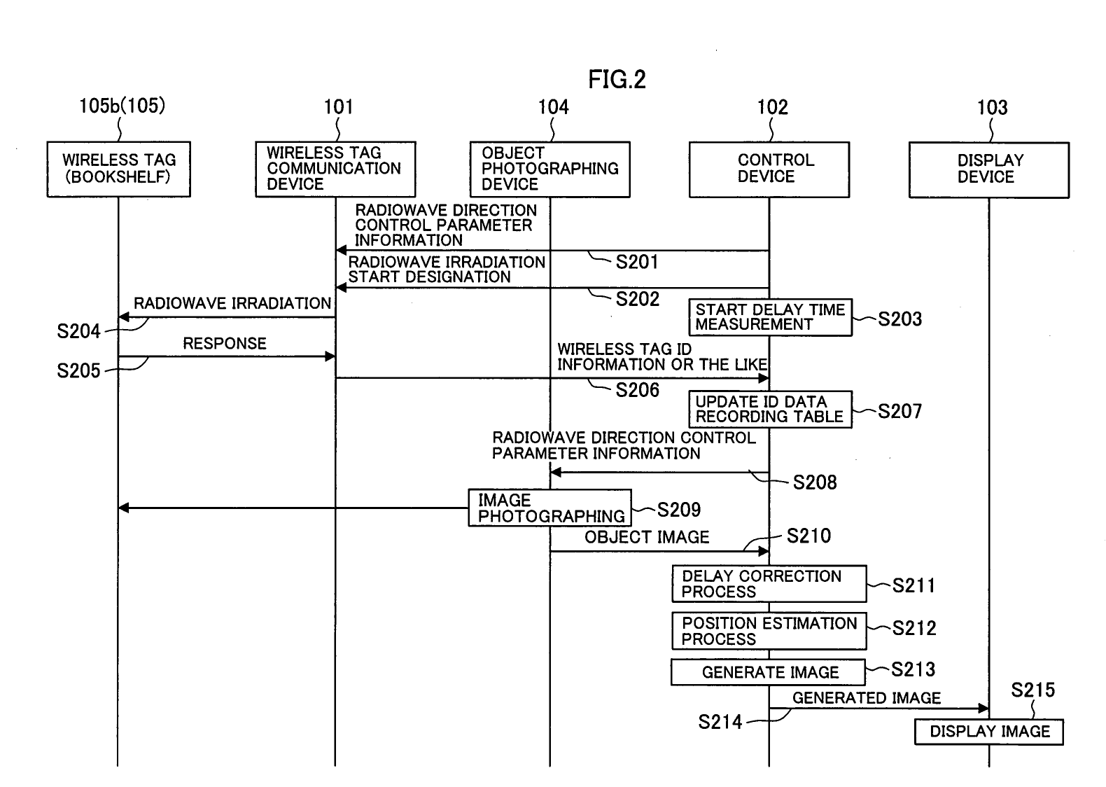

FIG. 2 is a sequence diagram showing an operation in which, in the wireless tag position estimation system 100, the wireless tag communication device 101 irradiates a radiowave on the bookshelf 105, estimates a position of the wireless tag 105b on the basis of a status of a response from the wireless tag 105b, and displays information visualized on the display device 103 with respect to the estimated position.

The information of the radiowave direction control parameter 102d is transmitted from the control device 102 to the wireless tag communication device 101 (S201).

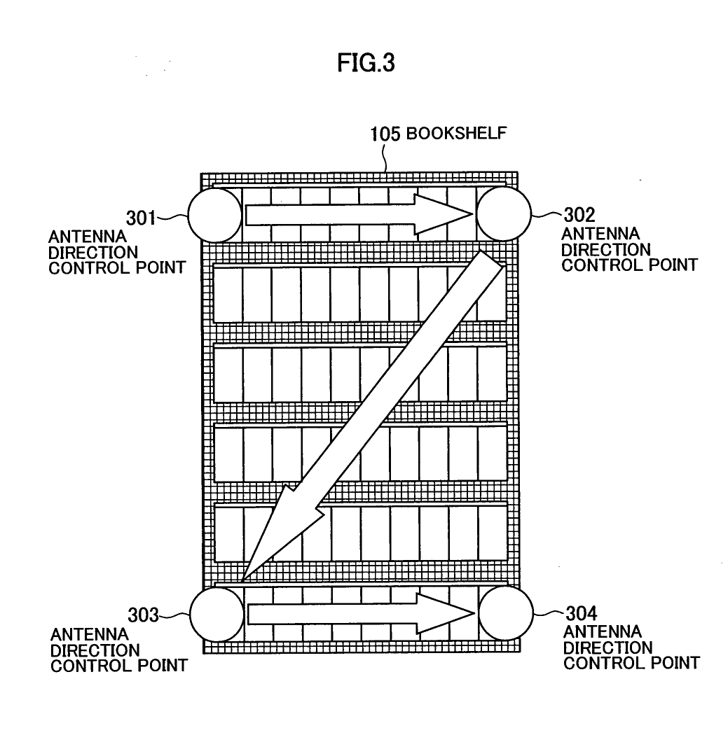

It is assumed that the information of the radiowave direction control parameter 102d is used to irradiate a radiowave to draw a Z-shaped track as shown in FIG. 3. Irradiation of a radiowave from an antenna direction control point 201 is started. Radiowaves are sequentially irradiated from an antenna direction control point 202, an antenna direction control point 203, and an antenna direction control point 204 in the order named while changing irradiation directions. The radiowave is irradiated from the antenna direction control point 201 to the antenna direction control point 202 for 0.2 seconds, the radiowave is irradiated from the antenna direction control point 202 to the antenna direction control point 203 for 0.2 seconds, and the radiowave is irradiated from the antenna direction control point 203 to the antenna direction control point 204 for 0.2 seconds. That is, it is assumed that the radiowaves are irradiated for a total of 0.6 seconds.

A signal which designates the wireless tag communication device 101 to start irradiation of a radiowave is transmitted from the control device 102 (S202).

The control device 102 starts measurement of delay time and waits for receiving information from the wireless tag communication device 101 (S203).

When the wireless tag communication device 101 receives the signal of the radiowave irradiation start designation, the wireless tag communication device 101 controls the radiowave irradiation unit 101b on the basis of the information of the radiowave direction control parameter 102d to irradiate a radiowave on the bookshelf 105 (S204).

In response to radiowave irradiation from the wireless tag communication device 101, the wireless tag 105b returns a radiowave signal of the response (S205). As described above, contents of the response content include the ID information or the like of the wireless tag 105b.

The ID information or the like serving as the contents of the response is transferred from the wireless tag communication device 101 which receives the radiowave of the response from the wireless tag 105b to the control device 102 (S206).

When the control device 102 receives the ID information or the like, the ID data recording table 102f is updated on the basis of the received information in the control device 102 (S207). The information updating is performed by adding the received ID information or the like and setting the receiving time as delay time. As described above, it is assumed that the delay time mentioned here is time defined by setting time of the start of delay time measurement in step 203 at 0 seconds.

Subsequently, operations in steps S204 to S207 are repeated until radiowave irradiation in step S204 is finished.

In this case, as delay time of the ID data recording table 102f, recording is performed such that 0.04 seconds are set as a minimum unit. For example, delay time shorter than 0.02 seconds is defined as 0 second, and delay time equal to or longer than 0.02 seconds and shorter than 0.06 seconds is defined as 0.04 seconds. It is assumed that responses are obtained from the wireless tag 105b a total of seven times, i.e., delay times of 0.04 second, 0.08 second, 0.12 second, 0.16 second, 0.20 second, 0.32 second, and 0.40 second.

On the other hand, in the object photographing device 104, an image of a periphery of the wireless tag 105b is photographed before, after, or simultaneously with steps S201 to S206, and information of the image is acquired. An operation of acquiring image information will be described below.

The information of the radiowave direction control parameter 102d is transmitted from the control device 102 to the object photographing device 104 (S207).

When the information of the radiowave direction control parameter 102d is received, in the object photographing device 104, a photographing range of the image is determined on the basis of the information, and the image is photographed (S209). In this case, as shown in FIG. 3, the entire bookshelf 105 including a slightly outer side of the track obtained by a radiowave output such that the wireless tag communication device 101 draws a Z-shaped track is photographed as an image.

Information of the photographed image is transmitted from the object photographing device 104 to the control device 102 (S210). With the above operations, the control device 102 acquires image information around the wireless tag 105b.

Upon completion of reception of information from the wireless tag communication device 101 (S201 to S207), in the control device 102, the ID data recording table 102f is corrected on the basis of the contents of the delay correction table 102e (S211). In this case, for example, average response time of a wireless tag of the same type as that of the wireless tag 105b is 0.04 second, and it is assumed that the information is stored in the delay correction table 102e. As described above, in the ID data recording table 102f, the delay times measured with respect to the wireless tag 105b are 0.04 second, 0.08 second, 0.12 second, 0.16 second, 0.20 second, 0.32 second, and 0.40 second, respectively. Correction is performed such that 0.04 second are subtracted from each of the delay times to obtain 0 second, 0.04 second, 0.08 second, 0.12 second, 0.16 second, 0.28 second, and 0.36 second. When the corrected delay time is equal to or longer than 0.6 second (at this time, the radiowave irradiation of the wireless tag communication device 101 has been finished), the delay time is further corrected to 0.6 second.

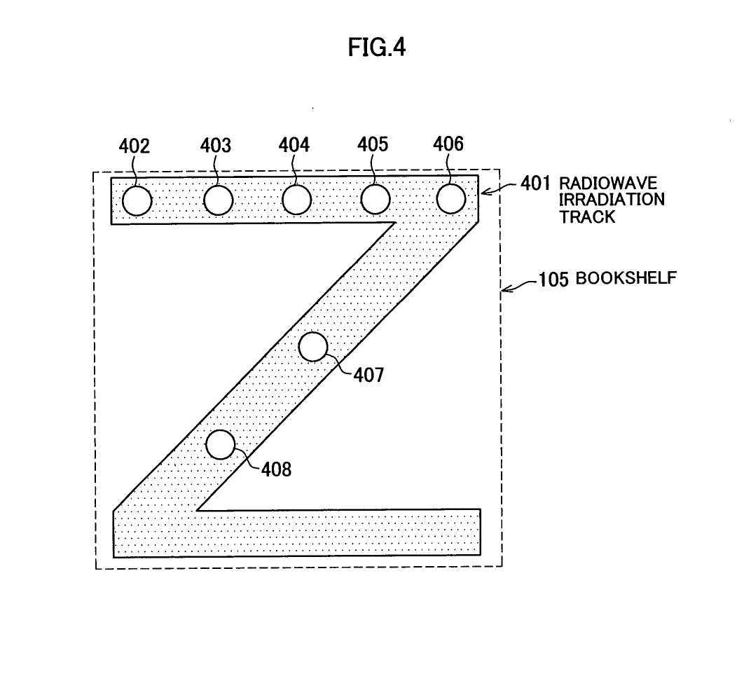

In the control device 102, on the basis of the radiowave direction control parameter 102d and the information of the ID data recording table 102f, the position of the wireless tag 105b is estimated (S212). At this time, the ID data recording table 102f and the radiowave direction control parameter 102d can acquire information about a position on which a radiowave is irradiated on the bookshelf 105 when a response from the wireless tag 105b is obtained. FIG. 4 shows the position information when the response is obtained. On the bookshelf 105, a Z-shaped radiowave irradiation track 401 is present, and response positions (402 to 408) are expressed on the track. In this case, since a large number of response positions are present on the upper side in the vertical direction of the bookshelf 105 and a large number of response positions are present on the left side in the horizontal direction of the bookshelf 105, it may be estimated that the wireless tag 105b is present at the upper left of the bookshelf 105. A position of a center of gravity of the response potions (402 to 408) may be set as an estimated position of the wireless tag 105b. As described above, position information of the wireless tag 105b is estimated.

In the control device 102, on the basis of the position information of the wireless tag 105b estimated in step S212 and image information of the bookshelf 105 received from the object photographing device 104 in step S210, a visual image of the position of the wireless tag 105b is generated (S213). The image generated here is shown in FIG. 5 as described above.

The image generated in step S213 is input from the control device 102 to the display device 103 (S214). The display device 103 displays the image for a user (S214).

### (A-3) Effect of First Embodiment

According to the first embodiment, in the wireless tag position estimation system 100, a radiowave is irradiated from the wireless tag communication device 101 to the wireless tag 105b, and a position of the wireless tag 105b is estimated on the basis of a status of the response. For this reason, regardless of the appearance of an article (book 105a) on which the wireless tag 105b is fitted, the position can be estimated. Therefore, even though articles which are slightly different in appearance such as shape or color and on which wireless tags are fitted are arranged, the positions of the articles can be specified. This uses the characteristics of an operation manner of a wireless tag. That is, the wireless tag 105b reliably responds when the wireless tag 105b is located in a direction to a central part of a radiowave generated from the wireless tag communication device 101, and the wireless tag 105b rarely responds when the wireless tag 105b is located separately from the central part of the generated radiowave. In this manner, when a large number of products of the same category are arranged, or when products are packaged in the same modes of packing, operation time required for finding a specific article can be considerably shortened advantageously.

Since the delay correction table 102e is arranged, even though times from when radiowaves are irradiated to when responses are obtained are different from each other in types of wireless tags or products, the times can be corrected to a predetermined reference. For example, in this embodiment, if the delay correction table 102e is not arranged, and when response time of the wireless tag 105b is about 0.4 second, all the response positions (402 to 408) in FIG. 4 are recorded on the lower side of the Z-shaped track. As a result, the estimated position of the wireless tag 105b is on the lower side of the bookshelf 105, and accuracy of the estimated position is deteriorated. Therefore, when the delay correction table 102e is arranged, even though wireless tags of a large number of types are mixed, accuracy of the estimated positions of the wireless tags is not deteriorated. This is preferably applied when “active tags” operated by built-in batteries and “passive tags” operated by electric power excited by an electromagnetic wave supplied from an external device are mixed. Since the passive tag requires a predetermined period of time until an electric power is excited, response time of the passive tag tends to be longer than that of the active tag.

### (B) Second Embodiment

A second embodiment of a wireless tag position estimation device, a wireless tag communication device, a wireless tag position estimation system, a wireless tag position estimation method, and a wireless tag position estimation program will be described in detail with reference to the accompanying drawings.

### (B-1) Configuration of Second Embodiment

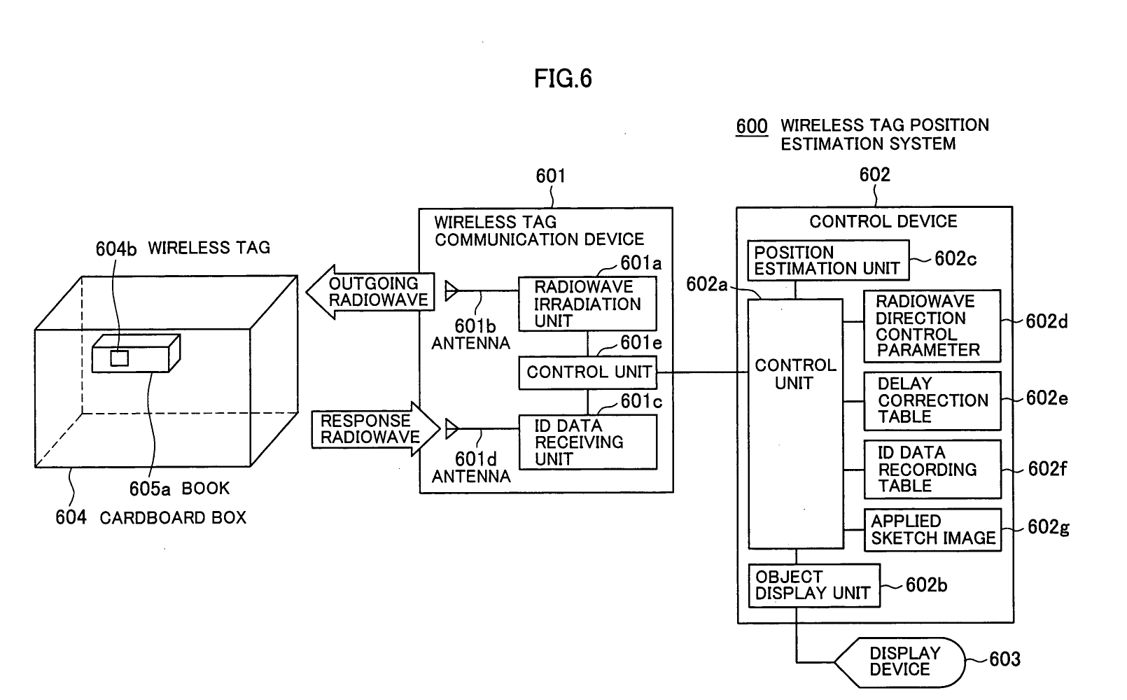

FIG. 6 is a block diagram showing a functional configuration of a wireless tag position estimation system according to the second embodiment.

In the first embodiment, a book 105a (wireless tag 105b) serving as an object from which position information is acquired is accommodated in the bookshelf 105, and the book 105a is visually checked from the outside. However, in the second embodiment, a book 604a (wireless tag 604b) is accommodated in a cardboard box 604 and cannot be visually checked from the outside. In the bookshelf 105, the book 105a is planarly (two-dimensionally) arranged. However, the book 604a in the cardboard box 604 is cubically (three-dimensionally) stacked and arranged. As described above, by the difference between arrangement statuses of articles the positions of which are to be estimated, a configuration required for a wireless tag position estimation system 600 according to the second embodiment is different from the wireless tag position estimation system 100 according to the first embodiment.

Contents of the configuration of the second embodiment different from these in the first embodiment will be described below.

As described above, in this embodiment, the book 604a on which the wireless tag 604b is fitted is accommodated in the cardboard box 604. Although not shown, for example, 48 books on which the wireless tag is fitted on three stages, respectively, i.e., upper, middle, and lower stages (total of 144 books) are accommodated in the cardboard box 604.

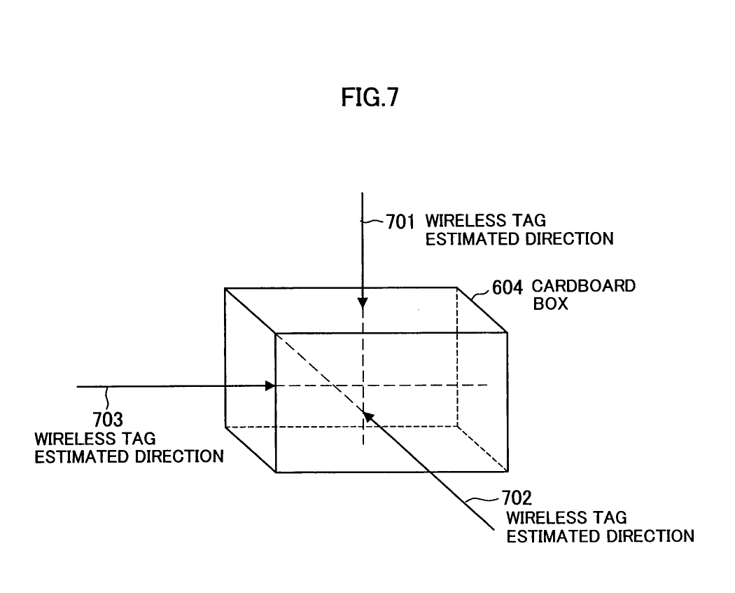

In the wireless tag communication device 101 according to the first embodiment, the radiowave irradiation unit 101b is fixed to one position to irradiate a radiowave toward the bookshelf 105. The second embodiment is different from the first embodiment in the following point. That is, in a wireless tag communication device 601 according to the second embodiment, a radiowave irradiation unit 601b irradiates radiowaves from a plurality of positions to the cardboard box 604 as shown in FIG. 7. In order to irradiate radiowaves from a plurality of positions, for example, the wireless tag communication device 601 may be constructed to be automatically or manually moved. Alternatively, the radiowave irradiation units 601b may be arranged at positions on which radiowaves are irradiated, respectively.

In the first embodiment, the ID data recording table 102f of the control device 102 records a response status from the wireless tag 105b when a radiowave is irradiated from only one position as described above. However, since an ID data recording table 602f according to the second embodiment records information obtained when radiowaves are irradiated in a plurality of directions, recording is performed by structures which can be classified by the directions. As a method of classification, for example, a structure which sets flags which discriminates positions from which radiowaves are irradiated to perform recording is given.

In the first embodiment, the position estimation unit 102c of the control device 102 estimates a position of the wireless tag 105b on the basis of information obtained when a radiowave is irradiated from only one position as described above. However, in the second embodiment, since a position estimation unit 602c of a control device 602 estimates a position of the wireless tag 604b on the basis of information obtained when radiowaves are irradiated from a plurality of positions, different estimation methods are used. For example, in this embodiment, the radiowave irradiation unit 601b is arranged such that radiowave irradiation can be performed in three directions perpendicular to the upper surface, the front surface, and the left-side surface of the cardboard box 604, and it is assumed that the position of the radiowave irradiation unit 601b is estimated on the basis of the response status of the wireless tag 604b with respect to radiowave irradiation. An example of the estimation method of the wireless tag 604b mentioned here will be described below.

By the same method as that in the first embodiment, a direction of the wireless tag 604b is estimated when the wireless tag 604b is viewed from the respective positions. As described above, since a status of a response from the wireless tag 604b is recorded on the ID data recording table 602f in such a form that the statuses can be classified by the positions of the radiowave irradiation, estimated directions of the wireless tag 604b when viewed from the directions can be calculated.

FIG. 7 is a diagram showing line segments of the cardboard box 604 in estimated directions of the wireless tag 604b when viewed from positions (upper surface, front surface, and left-side surface). An estimated direction from the upper surface is defined as a wireless tag estimated direction 701, an estimated direction from the front surface is defined as a wireless tag estimated direction 702, and an estimated direction from the left-side surface is defined as the wireless tag estimated direction 703. At this time, when all the wireless tag estimated directions (701, 702, and 703) are lines crossing at one point, the position of the point can be calculated as an estimated position of the wireless tag 604b. However, when the directions do not cross, for example, with respect to combinations of two lines selected from the three lines (three combinations), the shortest lines between the lines are calculated, and a center of a smallest sphere including the three calculated lines can be calculated as an estimated position of the wireless tag 604b. The “combinations of two lines selected from the three lines” are three combinations, i.e., a combination of the wireless tag estimated direction 701 and the wireless tag estimated direction 702, a combination of wireless tag estimated direction 702 and the wireless tag estimated direction 703, and a combination of the wireless tag estimated direction 701 and the wireless tag estimated direction 703. When the estimated position is outside the cardboard box 604, a point closest to the estimated position in the cardboard box 604 is determined as an estimated position.

In the first embodiment, photographing is performed by the object photographing device 104 to acquire image information of the bookshelf 105, and the position of the wireless tag 105b is visualized by using the image information. However, in the second embodiment, since the book 604a (wireless tag 604b) cannot be visually checked from the outside and cannot be photographed, the control device 602 includes an applied sketch image 602g having a sketch of a cardboard box as image information in advance.

As an example of an image generated by an object display unit 602b, a circle or the like serving as a mark may be written in a point at which the wireless tag 604b is estimated to be located on the applied sketch image 602g. As in this embodiment, when the books 604a are only filled in three stages in the cardboard box 604, a mark may be written in an estimated position obtained when the cardboard box 604 is viewed from the upper surface, and a stage number of the estimated position may be expressed as a character.

### (B-2) Operation of Second Embodiment

Various operations of the wireless tag position estimation system 600 according to the second embodiment having the above configuration will be described below.

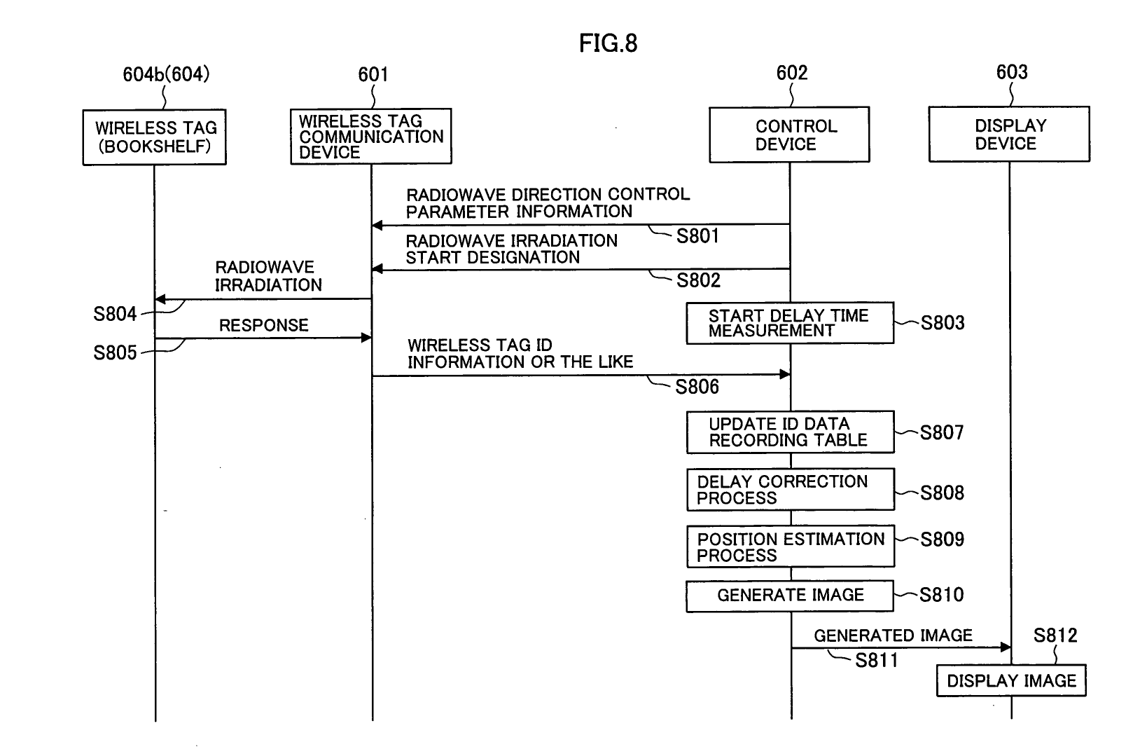

FIG. 8 is a sequence diagram showing an operation in which the wireless tag communication device 601 irradiates radiowaves from the three positions (upper surface, front surface, and left-side surface) toward the cardboard box 604, the positions are estimated on the basis of a status of a response of the wireless tag 604b, and information about the estimated position visualized on a display device 603 is displayed for a user.

Information of a radiowave direction control parameter 602d is transmitted from the control device 602 to the wireless tag communication device 601 (S801).

A signal which designates the wireless tag communication device 601 to start radiowave irradiation is transmitted from the control device 602 (S802).

The control device 602 starts measurement of delay time and waits for receiving information from the wireless tag communication device 601 (S803).

When the wireless tag communication device 601 receives the signal of the radiowave irradiation start designation, the wireless tag communication device 601 controls the radiowave irradiation unit 601b on the basis of the information of the radiowave direction control parameter 602d to irradiate a radiowave on the cardboard box 604 (S804).

In response to radiowave irradiation from the wireless tag communication device 601, the wireless tag 604b transmits a radiowave signal of the response (S805). As described above, it is assumed that information of the response includes ID information or the like of the wireless tag 604b.

When the wireless tag communication device 601 receives a response from the wireless tag 604b, the wireless tag communication device 601 transfers the ID information or the like of the response to the control device 602 (S806). At this time, as the contents of the ID information or the like, as described above, information about a position from which a radiowave is irradiated when the response is obtained is also transferred.

When the control device 602 receives the ID information or the like, the control device 602 updates the ID data recording table 602f on the basis of the received information (S807). The information is updated by adding the received ID information or the like and setting the receiving time as delay time.

Subsequently, operations in steps S804 to S807 are repeated until radiowave irradiation in step S804 is finished. The operations in steps S801 to S807 are sequentially performed from the three positions (upper surface, front surface, and left-side surface) every direction. For example, a radiowave is irradiated from the upper surface to perform the operations in step S801 to S807, and the operations are performed with respect to the front surface and then, to the left-side surface. When two or less radiowave irradiation units 601b are arranged, the wireless tag communication device 601 is moved to perform a repeated operation similarly.

In the control device 602, with respect to the ID data recording table 602f, correction is performed on the basis of the contents of a delay correction table 602e (S808). Although the correction is performed by the same operation as that in step S211 in FIG. 2 in the first embodiment, it is assumed that correction does not especially occur in the second embodiment.

In the control device 602, on the basis of the information of the radiowave direction control parameter 602d and the ID data recording table 602f, a position of the wireless tag 604b is estimated (S809).

In the control device 602, on the basis of the information of the position of the wireless tag 604b estimated in step S809 and image information of the applied sketch image 602g, an image which enables to visualize the position of the wireless tag 604b is generated (S810).

An image generated in step S810 is input from the control device 602 into the display device 603 (S811), and the display device 603 displays the image for a user (S812).

### (B-3) Effect of Second Embodiment

According to the wireless tag position estimation system 600 of the second embodiment, in addition to the same effect as that in the first embodiment, the following effects can be obtained.

According to the second embodiment, a position of the wireless tag 604b in the cardboard box 604 is estimated by a configuration in which radiowaves are irradiated in a plurality of directions of the wireless tag communication device 601. In this manner, as in a box or a storage, even though an article on which a wireless tag is fitted is arranged such that the article cannot be penetrated in one direction, a position of a target article can be specified. As in the first embodiment, operation time required for finding a specific article can be considerably shortened advantageously.

When a large number of articles are stacked and accommodated in a large cardboard box, an upper article must be picked first to pick a lower article arranged under the upper article. Alternatively, when a large number of boxes are stacked in a storage, an upper box must be picked first to pick a lower box arranged under the upper box. Therefore, if a position where a target article is located in a box or a position of a box in which a target article is located in a storage is known in advance, a target article can be found by minimum trouble.

In the second embodiment, on the basis of the line segments of the three wireless tag estimated directions (701, 702, and 703), a position of the wireless tag 604b is estimated. However, when the number of line segments of the wireless tag estimated directions is large, the position can be estimated on the basis of a large number of samples. For this reason, accuracy of the estimated position tends to be improved. When a “sphere” calculated in the process of estimating a position of the wireless tag 604b is small, accuracy of the estimated position tends to be improved. For example, when the size of the sphere is almost equal to the size of the cardboard box 604, even though a center point can be calculated, it is doubtful that the position of the wireless tag 604b is equal to the center point of the sphere. In contrast to this, when the sphere is small, it is estimated that the wireless tag 604b is probably very close to the center.

### (C) Another Embodiment

(C-1) In each of the embodiments, the intensity of a radiowave irradiated from the radiowave irradiation unit (101b or 601b) of the wireless tag communication device (101 or 601) is adjusted to make it possible to improve accuracy of an estimated position of the wireless tag (105b or 604b).

As an adjusting method, for example, a wireless tag position information acquiring system (100 or 600) is operated while stepwisedly changing the intensities of radiowave irradiation to adjust an estimated position of a target wireless tag (105b or 604b) and an actual position such that a difference between the positions is minimum. That is to cope with the following case. That is, for example, when a radiowave to be irradiated is excessively strong, a wireless tag located at a position considerably separated from a center point on which the radiowave is irradiated responds at a high probability, and the accuracy of the estimated position is remarkably deteriorated. On the other hand, when the radiowave to be irradiated is excessively weak, since only a wireless tag which is very close to the center point on which the radiowave is irradiated responds, a respond required to estimate a position may not be obtained. Information about the intensity of the radiowave may be added to the radiowave direction control parameter (102d or 602d), to make it possible to control the intensity of radiowave irradiation performed by the radiowave irradiation unit (101b or 601b). In this manner, since the intensity of the radiowave irradiation performed by the radiowave irradiation unit (101b or 601b) can be dynamically controlled, an optimum intensity can be selected depending on statuses of a range in which the radiowave is irradiated, and position estimation can be performed at a higher accuracy.

(C-2) In the first embodiment, even after the radiowave irradiation in step S204 in FIG. 2 is finished, the control device 102 may wait to receive information from the wireless tag communication device 101. As waiting time, for example, a certain period of time may be applied, or response time of a wireless tag having the longest delay time may be applied with reference to the delay correction table 102e. As described above, although time depending on the type or the like of the wireless tag 105b is required as time between when the wireless tag 105b receives an irradiated radiowave and when the wireless tag 105b responds, by the above waiting, the wireless tag communication device 101 can prevent reception of a response of the wireless tag 105b to the latest radiowave irradiation from being impossible.

(C-3) In each of the embodiments, the radiowave irradiation unit (10lb or 601b) irradiates a radiowave while changing directions of irradiation of the radiowave. However, this irradiation may be relative to irradiation of the wireless tag (105b or 604b) the position of which is to be estimated. For example, when a position of an article in a cardboard box is to be estimated, a direction of a radiowave to be transmitted is fixed separately from the center of a turntable, the cardboard box is placed on the turntable, and the turntable is rotated. At this time, a radiowave is consequently output to draw a circular track on the cardboard box.

(C-4) In each of the embodiments, a position of a wireless tag fitted on a static article is estimated. However, even though an article on which a wireless tag is fitted moves, an amount of movement of the article is designed to be corrected to make it possible to estimate a position of the article. This is preferably applied to a case in which a specific article is tracked and monitored.

(C-5) According to each of the embodiments, since positions of all the books (105a or 604a) in the bookshelf 105 or the cardboard box 604 can be estimated. For this reason, the invention can be applied to the following case. That is, on the basis of information of an image or the like obtained by visualizing position information, book titles, author names, and publisher names of the books, a book database can be formed.

In this manner, for example, in order to check that books are arranged in order of author names according to the Japanese syllabary, the contents of the database may be only checked without actually checking bookshelves. In this check, when it is found that a book of an author such as “Natsume” having a capital letter in the “Na line” of the 50-character kana syllabary is erroneously put on a bookshelf on which books of authors having capital letters in the “A line, Ka line, and Sa line” of the 50-character kana syllabary are arranged in order of the author names according to the Japanese syllabary, a position of the book erroneously arranged can be checked on a visualized image by only a searching operation for the book database. At this time, even though a position of a book (to be originally arranged) of an author having a capital letter in the “Na line”, the position can also be checked by only a searching operation for the database. For this reason, the erroneous arrangement is detected, and an operation of returning the book to a correct position can be performed within short operation time. Furthermore, at this time, information about a position of another book of the author “Natsume” can be displayed, or information on a position of a book immediately before or immediately after the book of the author “Natsume” can be displayed.

Alternatively, according to the book database, in a book store or a library, an out-of-stock book can be checked by only operating the database. Furthermore, in order to restock an out-of-stock book, information of a position where the book is restocked can be displayed as a visualized image. For this reason, a quantity of work for restocking an out-of-stock article can be reduced.

Detection or the like of an erroneously arranged book or an out-of-stock book can also be entirely automated by a searching process for a database by a computer.

(C-6) In each of the embodiments, the radiowave irradiation unit (101b or 601b) of the wireless tag communication device (101 or 601) irradiates a radiowave having a directivity on the wireless tag (105b or 604b). However, the ID data receiving unit (101d or 601d) may be designed to receive a radiowave in only a specific direction. In the embodiment, a position of the wireless tag (105b or 604b) is estimated on the basis of information on a position and a direction in/on which a radiowave is irradiated. In this case, the position and the direction are replaced with a position and a direction on/in which a radiowave is received, the position can be similarly estimated. At this time, as the antenna (101e or 601e), for example, as in the radiowave irradiation unit (101b or 601b), an existing a phased array antenna or the like can be applied. The radiowave irradiation unit (101b or 601b) and the ID data receiving unit (101d or 601d) may share the same antenna to irradiate a radiowave having a directivity in a predetermined direction and to receive only a radiowave in the predetermined direction.

(C-7) In each of the embodiments, when the wireless tag communication device (101 or 601) communicates with the wireless tag (105b or 604b), a radiowave may be irradiated on a position estimated by the control device (102 or 602). In this manner, a stronger radiowave can be irradiated on the wireless tag communication device (101 or 601). For this reason, a communication error rate can be reduced advantageously. This may be applied to not only reading of information of the wireless tag (105b or 604b) but also another communication such as writing.

With respect to the ID data receiving unit 101d, the antenna (101e or 601e) may be controlled to improve a receiver sensitivity to a radiowave transmitted from a position of the wireless tag (105b or 604b) estimated by the control device (102 or 602). The contents of the control, for example, include a change in direction of the antenna (101e or 601e). In this manner, as in radiowave irradiation, a communication error rate can be advantageously reduced in radiowave reception.

1. A wireless tag communication device which transmits and receives information to/from a wireless tag with wireless communication and which provides information related to the wireless tag to a wireless tag position estimation device which estimates a position of the wireless tag, comprising:
radiowave irradiation means which irradiates a radiowave to transmit information to the wireless tag;
radiowave receiving means which receives a response radiowave from the wireless tag in response to radiowave irradiation by the radiowave irradiation means; and
wireless tag response information transmission means which transmits information related to a communication direction obtained by transmission/reception with the wireless tag to the wireless tag position estimation device, wherein
at least one of that the radiowave irradiation means irradiates a radiowave having a directivity in a predetermined direction at a predetermined position and that the radiowave receiving means receives only a response radiowave transmitted from the predetermined direction at the predetermined position is applied.

2. The wireless tag communication device according to claim 1, wherein the radiowave irradiation means changes a direction of directivity of radiowave irradiation.

3. The wireless tag communication device according to claim 1, wherein the radiowave irradiation means irradiates radiowaves each having a directivity from a plurality of positions to the wireless tag.

4. The wireless tag communication device according to claim 1, wherein the radiowave irradiation means irradiates a radiowave having a directivity on the position of the wireless tag estimated by the wireless tag position estimation device to transmit information when the radiowave irradiation means communicates with the wireless tag.

5. The wireless tag communication device according to claim 1, wherein the radiowave receiving means changes a direction of directivity in which a response radiowave can be received.

6. The wireless tag communication device according to claim 1, wherein the radiowave receiving means receives the response radiowave from the wireless tag at a plurality of positions at which a direction of directivity in which a response radiowave can be received is set.

7. The wireless tag communication device according to claim 1, wherein the radiowave receiving means controls a directivity such that a receiver sensitivity to a radiowave in a direction of the position of the wireless tag estimated by the wireless tag position estimation device is preferable when the radiowave receiving means communicates with the wireless tag.

8. A wireless tag position estimation device which estimates a position of a wireless tag on the basis of information from a wireless tag communication device which transmits and receives information to/from the wireless tag, comprising:
wireless tag response direction estimation means which estimates information about a specific position at which a response radiowave from the wireless tag can be received in communication and a specific direction in which the response radiowave can be received in communication on the basis of the information from the wireless tag communication device; and
wireless tag position estimation means which estimates the position of the wireless tag on the basis of information of a plurality of response directions estimated by the wireless tag response direction estimation means.

9. The wireless tag position estimation device according to claim 8, further comprising
wireless tag estimation position visualizing image generating means which generates image information obtained by adding information related to the position of the wireless tag estimated by the wireless tag position estimation means to radiowave irradiation range image information serving as image information of a range in which the wireless tag communication device irradiates a radiowave.

10. The wireless tag position estimation device according to claim 9, further comprising
radiowave irradiation range image photographing means which determines a range in which an image is photographed in the range in which the wireless tag communication device irradiates a radiowave, photographs the image, and acquires information of the radiowave irradiation range image information.

11. The wireless tag position estimation system, comprising
the wireless tag communication device according to claim 1 and a wireless tag position estimation device which estimates a position of a wireless tag on the basis of information from a wireless tag communication device which transmits and receives information to/from the wireless tag, comprising:
wireless tag response direction estimation means which estimates information about a specific position at which a response radiowave from the wireless tag can be received in communication and a specific direction in which the response radiowave can be received in communication on the basis of the information from the wireless tag communication device; and
wireless tag position estimation means which estimates the position of the wireless tag on the basis of information of a plurality of response directions estimated by the wireless tag response direction estimation means.

12. A wireless tag position estimation method which estimates a position of a wireless tag, comprising:
a wireless tag communication device which transmits and receives information to/from the wireless tag, and a wireless tag position estimation device which estimates a position of the wireless tag on the basis of information from the wireless tag communication device, wherein
the wireless tag communication device has a configuration in which a direction of communication with the wireless tag when viewed from a certain position, and, with this configuration, information related to the acquired communication direction to the wireless tag position estimation device, and
the wireless tag position estimation device obtains information of a plurality of response directions representing a specific position at which a response radiowave from the wireless tag can be received in communication and a specific direction in which the response radiowave can be received in communication on the basis of the information from the wireless tag communication device and then estimates the position of the wireless tag.

13. The wireless tag position estimation program mounted on a computer which constructs a wireless tag position estimation device which estimates a position of the wireless tag on the basis of information from a wireless tag communication device which transmits and receives information to/from the wireless tag, wherein
the computer is caused to function as
wireless tag response direction estimation means which estimates information about a specific position at which a response radiowave from the wireless tag can be received in communication and a specific direction in which the response radiowave can be received in communication on the basis of the information from the wireless tag communication device; and
wireless tag position estimation means which estimates the position of the wireless tag on the basis of information of a plurality of response directions estimated by the wireless tag response direction estimation means.
